(19) United States
(12) Patent Application Publication
(10) Pub. No.: US 2004/0105268 A1
(43) Pub. Date: Jun. 3, 2004

(54) Foldable cloth strips of cloth lampshade

(76) Inventor: Shin-Ming Lin, Chang Hsu (TW)

Correspondence Address: Shin-Ming Lin, 235 Chung-Ho, Box 8-24, Taipei, TW

(21) Appl. No.: 10/304,713

(22) Filed: Nov. 29, 2002

(51) Int. Cl. F21V 1/16

(52) U.S. Cl. 362/357; 362/351

(57) ABSTRACT

A foldable cloth strips of a cloth lampshade is disclosed. The cloth lampshade has an upper fixing ring and a lower fixing ring. A cloth layer covers the lampshade. A plurality of decorating strips is longitudinally arranged out of the cloth layer and is spaced with an equal space. Each decorating strip is formed by sticking a cloth strip with a plastic supporting strip. Then the decorating strips are longitudinally adhered on the cloth layer of the cloth lampshade.

### BACKGROUND OF THE INVENTION

The present invention relates to lampshades, and particularly to a foldable cloth strips of a cloth lampshade.

In general, the lampshade can be classified as plastic lampshades and cloth lampshades. The plastic lampshade is unfoldable, but the cloth lampshade is foldable. Since the plastic lampshade is unfoldable, and thus the volume thereof is large. As a consequence, to transfer the plastic lampshades is a difficult work. However, this defect can be overcome by cloth lampshade.

In general, the cloth lampshade has an upper supporting ring, a lower supporting ring and a plurality of supporting strips to prop up the cloth lampshade. Generally, the supporting structure of the cloth lampshade is made as foldable so that the volume can be reduced. Moreover, since the supporting structure of the cloth lampshade will be seen by the light within the lampshade to emit out. To improve this defect, a plurality of decorating strips are adhered on the cloth to shielded the inner supporting structure. However, after the decorating strips are folded, they are wrinkled so as to present an unbeautiful outlook.

### SUMMARY OF THE INVENTION

A foldable cloth strips of a cloth lampshade is disclosed. The cloth lampshade has an upper fixing ring and a lower fixing ring. A cloth layer covers the lampshade. A plurality of decorating strips is longitudinally arranged out of the cloth layer and is spaced with an equal space. Each decorating strip is formed by sticking a cloth strip with a plastic supporting strip. Then the decorating strips are longitudinally adhered on the cloth layer of the cloth lampshade.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled perspective view of the decorating strips of the present invention.

### BRIEF DESCRIPTION OF THE PREFERRED EMBODIMENTS

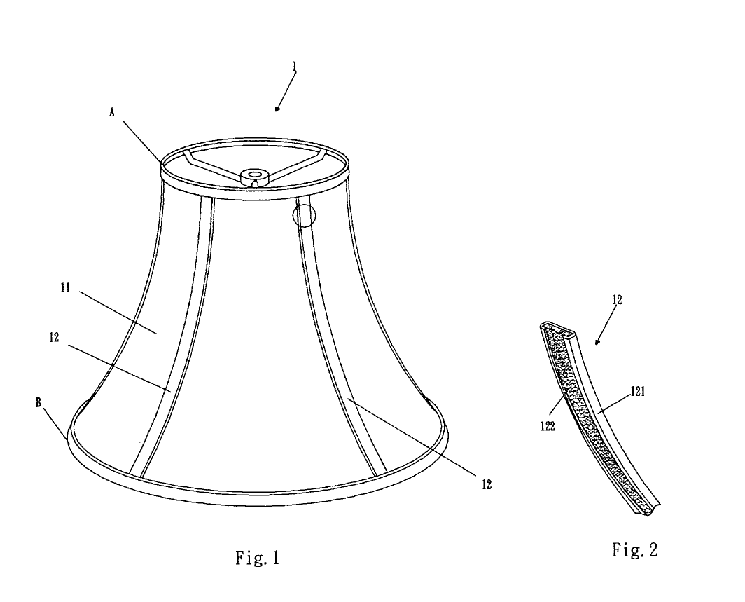

Referring to FIGS. 1 and 2, the cloth lampshade 1 of the present invention is formed by an upper fixing ring A and a lower fixing ring B. A cloth layer 11 covers the lampshade 1. A plurality of decorating strips 12 are longitudinally arranged out of the cloth layer 11 and the decorating strips 12 are spaced with an equal space. Each decorating strip 12 is formed by sticking a cloth strip 121 with a plastic supporting strip 122. Then the decorating strips 12 are longitudinally adhered on the cloth layer 11 of the cloth lampshade 1. The numbers of the decorating strips 12 adhered on the cloth layer 11 can be changed as desired. The color of the cloth strip 121 can also be changed as desired.

Moreover, the plastic supporting strips 122 are elastic and thus they are expandable and deformable. When the decorating strip 12 is resilient, the cloth lampshade 1 can be expanded. Thereby, since the decorating strips 12 are completely adhered to the cloth strip 121, after the cloth lampshade 1 is folded, the decorating strips 12 are supported without any wrinkle

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A foldable cloth strips of a cloth lampshade; the cloth lampshade having an upper fixing ring and a lower fixing ring; a cloth layer covering the lampshade; a plurality of decorating strips being longitudinally arranged out of the cloth layer and being spaced with an equal space; characterized in that:
each decorating strip is formed by sticking a cloth strip with a plastic supporting strip; then the decorating strips are longitudinally adhered on the cloth layer of the cloth lampshade.
